(19) United States
(12) Patent Application Publication
(10) Pub. No.: US 2024/0016593 A1
(43) Pub. Date: Jan. 18, 2024

(54) ELECTRIC TOOTHBRUSH FOR PETS

(71) Applicant: Proxihealthcare Inc., Ulsan (KR)

(72) Inventor: Young Wook Kim, Seoul (KR)

(21) Appl. No.: 18/373,289

(22) Filed: Sep. 27, 2023

Related U.S. Application Data
(63) Continuation of application No. PCT/KR21/19065, filed on Dec. 15, 2021.

(30) Foreign Application Priority Data
Mar. 31, 2021 (KR) 10-2021-0042410

(51) Int. Cl. A61D 5/00; A01K 13/00; A46B 13/02; A46B 15/00

(52) U.S. Cl. CPC A61D 5/00; A01K 13/001; A46B 13/02; A46B 15/0022; H02M 1/0003

(57) ABSTRACT

An electric toothbrush for pets includes: a head part including at least one electrode that receives a driving signal and generates an electric field corresponding to the driving signal, and a toothbrush head on which the at least one electrode is disposed; bristles coupled to the toothbrush head and including at least one opening that exposes a portion of the at least one electrode; a handle part connected to the head part and formed in a shape that may be held by a user; and a signal supply module provided in the handle part and configured to generate the driving signal by mixing an AC signal and a DC signal to supply the driving signal to the at least one electrode.

### CROSS REFERENCE TO RELATED APPLICATIONS

This application is a Bypass Continuation of International Application No. PCT/KR2021/019065, filed on Dec. 15, 2021, and claims priority from and the benefit of Korean Patent Application No. 10-2021-0042410, filed on Mar. 31, 2021, each of which is incorporated by reference for all purposes as if fully set forth herein.

### BACKGROUND

### Field

The present invention relates to an electric toothbrush for pets using special microcurrent electromagnetic waves.

### Discussion of the Background

Dental plaque is a sticky, transparent film that adheres to the surface of the teeth. The dental plaque is formed when numerous germs (bacteria) living in the oral cavity cling to certain components in saliva, and it is built up on and around the teeth.

When the dental plaque in the form of a very thin and transparent film is created, the bacteria inside it multiply. In this case, the bacteria in the plaque grow exponentially and increase in quantity using the sugar supplied when food is consumed. Acidic substances produced by the bacteria in the plaque dissolve the limescale in the teeth, causing tooth decay, and toxins cause inflammation in the gums.

The dental plaque itself is hard to see with the naked eye, and tends to accumulate in deep crevices on teeth, narrow gaps between teeth, and narrow gaps between teeth and gums. Because the plaque causes problems to teeth and surrounding tissues in these tight spaces, it's important to remove the plaque thoroughly without missing any spots.

The removal of the dental plaque is important not only for humans but also for pets. However, there is a problem that it is difficult to effectively remove the dental plaque from pets due to their resistance to toothbrushing and their limited patience, which often results in inadequate brushing.

The above information disclosed in this Background section is only for understanding of the background of the inventive concepts, and, therefore, it may contain information that does not constitute prior art.

### SUMMARY

An object of the present invention for solving the above-mentioned problems is to provide an electric toothbrush for pets that may effectively remove biofilm in the oral cavity by providing an electric field.

In addition, another object of the present invention is to provide an electric toothbrush for pets that amplifies the oral care effect by using a driving signal generated by mixing an AC signal and a DC signal.

Additional features of the inventive concepts will be set forth in the description which follows, and in part will be apparent from the description, or may be learned by practice of the inventive concepts.

According to one aspect of the invention, an electric toothbrush for pets includes: a head part including at least one electrode that receives a driving signal and generates an electric field corresponding to the driving signal, and a toothbrush head on which the at least one electrode is disposed; bristles coupled to the toothbrush head and including at least one opening that exposes a portion of the at least one electrode; a handle part connected to the head part and formed in a shape that can be held by a user; and a signal supply module provided in the handle part and configured to generate the driving signal by mixing an AC signal and a DC signal to supply the driving signal to the at least one electrode.

The at least one electrode may include a first electrode and a second electrode disposed to be spaced apart from each other and each having a first end and a second end located in opposite directions, and the toothbrush head may include: a pair of first openings that expose the first and second ends of the first electrode; and a pair of second openings that expose the first and second ends of the second electrode.

The head part may further include: a head body extending from the toothbrush head; a head cover closing a distal end of the head body; a first connection line and a second connection line disposed in the head body and connected to the first electrode and the second electrode, respectively, in the toothbrush head; and a fixture in which a pair of fixing grooves for fixing positions of the first connection line and the second connection line are formed along a longitudinal direction, wherein the fixture may be located between the toothbrush head and the head cover.

The head cover may include: a pillar member having a first guide groove into which a portion of the first connection line is inserted and a second guide groove into which a portion of the second connection line is inserted formed along the longitudinal direction; a first seating area and a second seating area, each of which is located on either side of the pillar member; at least one protrusion disposed around each of the first and second seating areas; and a guide wall disposed around the first seating area and the second seating area and formed to surround at least a portion of a lower region of the pillar member.

Each of the first electrode and the second electrode may further include a third end, which is one end of an electrode area formed by protruding and extending upward from a central area thereof.

The toothbrush head may further include: a third opening that exposes the third end of the first electrode; and a fourth opening that exposes the third end of the second electrode, wherein the third opening and the fourth opening may be located on a top surface of the toothbrush head.

The electric toothbrush for pets may further include a controller configured to control the signal supply module to change at least one of characteristics of the driving signal under user's control.

The characteristics of the driving signal may include an amplitude and a DC offset.

The signal supply module may include: a DC-DC converter that receives a battery voltage and converts it into an output voltage; a signal generator that generates the AC signal using the output voltage of the DC-DC converter; a filter that performs a filtering operation on the AC signal generated by the signal generator; and a calibrator that generates the driving signal by mixing the DC signal with the AC signal supplied through the filter.

The signal supply module may further include a voltage divider that divides the output voltage of the DC-DC converter to generate the DC signal.

According to the present invention, it is possible to provide an electric toothbrush for pets that can effectively remove biofilm in the oral cavity by providing an electric field.

In addition, according to the present invention, it is possible to provide an electric toothbrush for pets that amplifies the oral care effect by using a driving signal generated by mixing an AC signal and a DC signal.

It is to be understood that both the foregoing general description and the following detailed description are illustrative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate illustrative embodiments of the invention, and together with the description serve to explain the inventive concepts.

FIG. 1 is a diagram illustrating a pet electric toothbrush according to an embodiment of the present invention.

FIGS. 2A and 2B are diagrams illustrating a biofilm removal effect of a driving signal generated by mixing an AC signal and a DC signal.

FIG. 3 is a diagram illustrating an electric field generating device according to an embodiment of the present invention.

FIGS. 4A, 4B, and 4C are diagrams illustrating the waveform of a signal according to an embodiment of the present invention.

FIG. 5 is a diagram illustrating an electric field generating device according to another embodiment of the present invention.

FIG. 6 is a diagram illustrating a pet electric toothbrush according to an embodiment of the present invention in a specific form.

FIG. 7 is a drawing of the pet electric toothbrush shown in FIG. 6 with head and handle parts separated from each other.

FIG. 8 is a diagram of a head part shown in FIG. 6 with bristles separated therefrom.

FIG. 9 is a diagram illustrating a head part with bristles and electrodes removed.

FIG. 10A is a front view illustrating a connection relationship between a head cover, a connection line, a connection pin, and a fixture.

FIG. 10B is a side view illustrating a connection relationship between a head cover, a connection line, a connection pin, and a fixture.

FIG. 10C is a rear view illustrating a connection relationship between a head cover, a connection line, a connection pin, and a fixture.

FIG. 11 is a diagram illustrating a head cover according to an embodiment of the present invention.

FIG. 12 is a diagram illustrating a connection relationship between a connection line and a head cover shown in FIG. 11.

FIG. 13 is an exploded view illustrating an internal configuration of a handle part according to an embodiment of the present invention.

FIG. 14 is a diagram illustrating a pet electric toothbrush according to another embodiment of the present invention.

FIG. 15 is a top view of a head part shown in FIG. 14.

FIG. 16A is a front view of a head part shown in FIG. 14 with a toothbrush head and head body removed.

FIG. 16B is a side view of a head part shown in FIG. 14 with a toothbrush head and head body removed.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing illustrative features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, embodiments of the present invention will be described in detail with reference to the accompanying drawings. However, the present invention is not limited to the embodiments disclosed below and may be implemented in various different forms. Also, it should be understood that all modifications, equivalents, or replacements thereof are included within the subject matter and scope of the present invention.

Hereinafter, an electric toothbrush for pets according to an embodiment of the present invention will be described with reference to drawings related to embodiments of the present invention.

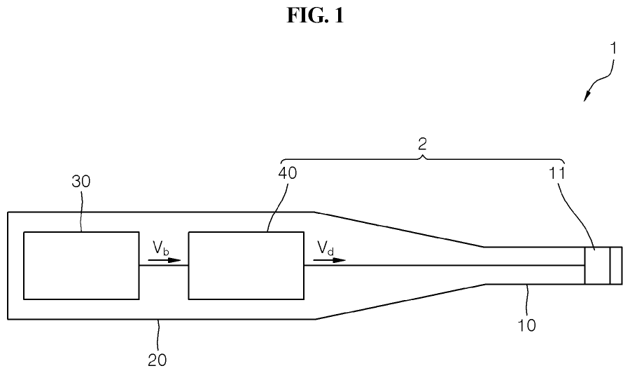

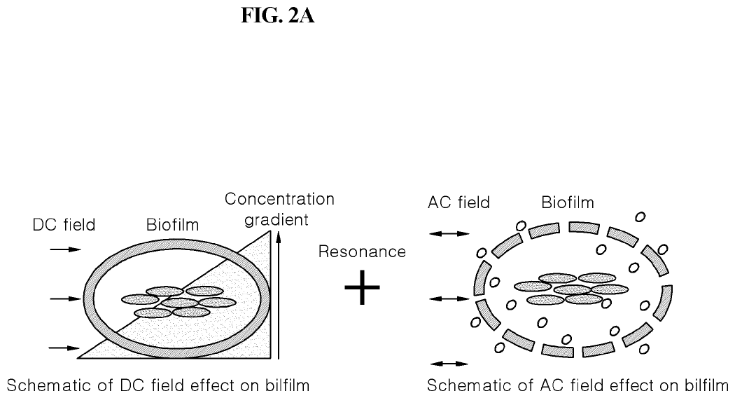

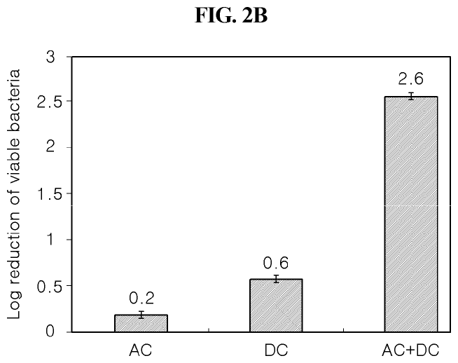

FIG. 1 is a diagram illustrating a pet electric toothbrush according to an embodiment of the present invention. FIGS. 2A and 2B are diagrams illustrating a biofilm removal effect of a driving signal generated by mixing an AC signal and a DC signal.

Referring to FIG. 1, a pet electric toothbrush 1 according to an embodiment of the present invention may include an electric field generating device 2, a head part 10, a handle part and a battery 30.

The electric field generating device 2 may include at least one electrode 11 that generates an electric field in response to a driving signal Vd, and a signal supply module 40 that supplies the driving signal Vd to the electrode 11.

The electrode 11 may be disposed on the head part 10 and may be electrically connected to the signal supply module 40 disposed on the handle part 20 to receive the driving signal Vd.

The electrode 11 may form an electric field based on electric energy of the driving signal Vd. This electric field may weaken the structure of dental plaque, and thus a user may effectively remove dental plaque in the oral cavity of a pet by using the pet electric toothbrush 1.

In addition, the pet electric toothbrush 1 may provide a microcurrent to the gums through the electrode 11, thereby relieving inflammation or pain in the gums.

When a plurality of electrodes 11 are disposed on the head part 10, at least one of the electrodes 11 may receive the driving signal Vd. In this case, an electrode serving as a ground electrode may be additionally installed on the head part 10.

The electrode 11 may be formed of a material such as brass, aluminum, conducting polymer, conducting silicon, or stainless steel, but is not limited thereto, and any material that is conductive may be used as an electrode material.

A separate groove or hole may be formed in the head part 10, the electrode 11 may be inserted into the groove or hole, and a portion of the electrode 11 may be exposed from the head part 10. In this case, the electrode 11 may have a shape that does not protrude outwardly from the head part 10, or may have a shape that protrudes outwardly from the head part 10.

The handle part 20 may be connected to the head part 10 and may have a shape that can be held by the user. A separate button or switch (not shown) for operating the pet electric toothbrush 1 may be provided on the handle part 20.

The signal supply module 40 may be located inside the handle part 20 and may generate the driving signal Vd using a battery voltage Vb supplied from the battery 30.

In particular, the signal supply module 40 generates the driving signal Vd by mixing an alternating current (AC) signal and a direct current (DC) signal.

Accordingly, the driving signal Vd includes both AC and DC components, and synergistic effects and resonance may occur due to simultaneous application of the AC and DC components, thereby enhancing the removal effect of a biofilm that causes dental plaque.

Referring to FIG. 2A, an electric field induced by the DC component may increase the structural stress of the biofilm by inducing an imbalance in the local distribution of charges, and an electric field induced by the AC component may increase the permeability into the outer protective substance through the generation of specific vibrations.

The synergistic effect between these AC and DC components may be observed in FIG. 2b. Specifically, compared to the biofilm removal effect when providing the electric fields induced by the AC component and DC voltage separately, it can be seen that when providing the electric fields induced by the AC component and DC voltage simultaneously in an overlapping manner, the biofilm removal effect is significantly superior.

Since the electric field induced by the DC component and the electric field induced by the AC component in response to the driving signal Vd supplied from the signal supply module 40 according to an embodiment of the present invention may be provided simultaneously from the electrode 11, an enhanced removal effect of the biofilm described above may be achieved.

In addition, by configuring the driving signal Vd in a form in which alternating current and direct current voltages are superimposed as described above, it can reduce the risk of electrical shock to the body and the pain that may be caused to the body, compared to the case where only direct current voltage is applied.

Meanwhile, the battery 30 may be accommodated inside the handle part 20 and may provide the battery voltage Vb to the signal supply module 40.

For example, the battery 30 may be set as a primary battery or secondary battery.

When the battery 30 is a primary battery, the user may periodically replace the battery 30, whereas when the battery 30 is a secondary battery, it may be charged through various charging methods.

For example, the battery 30 may be charged through a wireless charging method or a wired charging method while located within the handle part 20. Alternatively, the battery 30 may be separated from the handle part 20 and charged through a separate charging device.

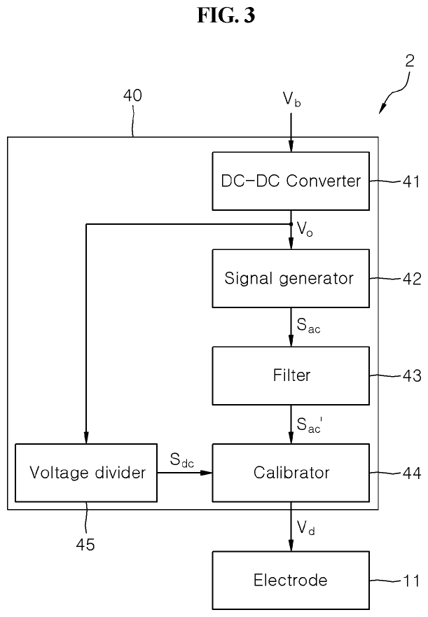

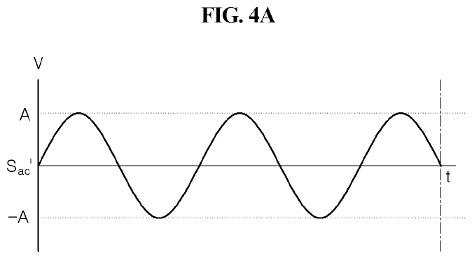

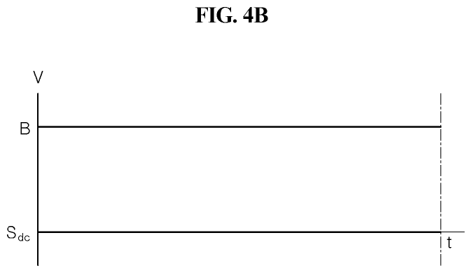

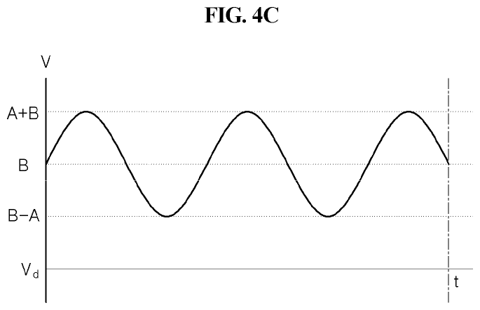

FIG. 3 is a diagram illustrating an electric field generating device according to an embodiment of the present invention. FIGS. 4A to 4C are diagrams illustrating the waveform of a signal according to an embodiment of the present invention. In particular, FIG. 4A shows a filtered AC signal Sac′, FIG. 4B shows a DC signal Sdc, and FIG. 4C shows the driving signal Vd generated by mixing the filtered AC signal Sac′ and the DC signal Sdc.

Referring to FIG. 3, the signal supply module 40 according to an embodiment of the present invention may include a DC-DC converter 41, a signal generator 42, a filter 43, and a calibrator 44, and may additionally include a voltage divider 45.

The DC-DC converter 41 may receive the battery voltage Vb from the battery 30, and may convert the battery voltage Vb into a predetermined level of output voltage Vo to output it.

The signal generator 42 may operate based on the voltage supplied from the DC-DC converter 41, and may generate an AC signal Sac with a predetermined frequency using the output voltage Vo of the DC-DC converter 41.

The signal generator 42 may be implemented using a known configuration, such as an oscillator or function generator, capable of generating an AC signal.

For example, the AC signal Sac may be set to a frequency of 1 KHz to 1000 MHz. This is because if the AC signal Sac is set to a low frequency of less than 1 KHz, the effect of removing dental plaque is reduced, and if the AC signal Sac is set to an ultra-high frequency of more than 1000 MHz, the effect of removing dental plaque is also reduced. Meanwhile, the AC signal Sac may be set to a frequency of 5 MHz to 15 MHz, which is suitable for the removal of dental plaque.

Additionally, the amplitude of the AC signal Sac may be set to 0.1 mV to 3V. This is because if the amplitude of the AC signal Sac is less than 0.1 mV, it is difficult to expect the dental plaque removal effect, and if the amplitude of the AC signal Sac exceeds 3V, there is a risk of generating toxic substances due to electrolysis of body fluids.

The filter 43 may perform a filtering operation on the AC signal Sac generated by the signal generator 42. For example, the filter 43 may include a low pass filter and may convert the AC signal Sac in a sawtooth wave form into the AC signal Sac′ in a sine wave form. However, the type of the filter 43 is not limited thereto, and various types of filters may be employed depending on the design structure.

The calibrator 44 may generate the driving signal Vd by mixing the DC signal Sdc with the AC signal Sac′ supplied through the filter 43. For example, the calibrator 44 may be implemented with an operating amplifier capable of summing (or superimposing) the AC signal Sac′ and the DC signal Sdc, but is not limited thereto.

Accordingly, an offset corresponding to the DC signal Sdc may be generated in the AC signal Sac′, and the driving signal Vd containing both AC and DC components may be generated.

Since the driving signal Vd contains all the characteristics of the AC signal Sac, the driving signal Vd may be set to a frequency of 1 KHz to 1000 MHz, and further, may be set to a frequency of 5 MHz to 15 MHz, which is more suitable for the removal of dental plaque. Additionally, the amplitude of the driving signal Vd may be set to 0.1 mV to 3V.

Referring to FIG. 4A, the calibrator 440 may receive the AC signal Sac′ having an amplitude of A volt (V) from the filter 43, and may superimpose the DC signal Sdc of B volt (V) as shown in FIG. 4B on the corresponding AC signal Sac′ to produce a final driving signal Vd as shown in FIG. 4C.

In this case, the voltage value of the DC signal Sdc may be set to be equal to or greater than the amplitude of the AC signal Sac′. Accordingly, the voltage value of the driving signal Vd may be set to 0 or more.

Ultimately, the DC offset value of the driving signal Vd may be set to be equal to or greater than the amplitude of the driving signal Vd.

If the DC offset value of the driving signal Vd is less than the amplitude value of the driving signal Vd, it will result in an interval where the voltage of the driving signal Vd has a negative value, and since the voltage in the interval has a negative value, a loss of electrical energy occurs.

However, as in the embodiment of the present invention, when the DC offset value of the driving signal Vd is set equal to or greater than the amplitude of the driving signal Vd, the voltage of the driving signal Vd is always greater than or equal to zero, resulting in no loss of electrical energy.

Meanwhile, the DC signal Sdc may be generated by the voltage divider 45. For example, the voltage divider 45 may receive the output voltage Vo of the DC-DC converter 41, and perform voltage division on the output voltage Vo to generate the DC signal Sdc.

The voltage divider 45 may be composed of a resistor string for dividing the output voltage Vo, but is not limited thereto.

When the output voltage Vo of the DC-DC converter 41 is suitable to be used directly to generate the driving signal Vd, the corresponding output voltage Vo may serve as the DC signal Sdc. In this case, the voltage divider 45 may be omitted, and the output voltage Vo of the DC-DC converter 41 may be inputted to the calibrator 44.

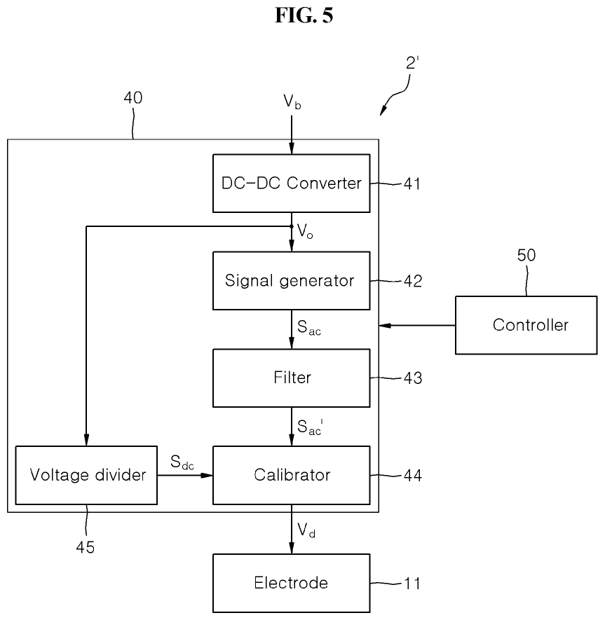

FIG. 5 is a diagram illustrating an electric field generating device according to another embodiment of the present invention.

Referring to FIG. 5, in an electric field generating device 2′ according to another embodiment of the present invention, the signal supply module 40 may change at least one characteristic of the driving signal Vd under the user's control. In addition, the electric field generating device 2′ may additionally include a controller 50 that controls the signal supply module 40 in response to the user's input.

For example, the characteristics of the driving signal Vd may include the amplitude and DC offset of the driving signal Vd.

Accordingly, by adjusting at least one of the amplitude and DC offset of the driving signal Vd, the user may set an optimal driving signal Vd suitable for the pet. This function enables customized oral care for pets considering their characteristics.

In this case, the user's input method for controlling the characteristics of the driving signal Vd may be through a button or switch installed on the pet electric toothbrush 1 or the electric field generating device 2′, and the user may adjust or set the characteristics of the driving signal Vd by manipulating the button or switch installed on the pet electric toothbrush 1 or the electric field generating device 2′.

When setting information for the driving signal Vd is inputted through button or switch manipulation by the user, the controller 50 may control the signal supply module 40 to provide the driving signal Vd having amplitude and DC offset values corresponding to the inputted setting information.

The controller 50 may change the amplitude of the AC signal Sac by controlling the signal generator 42. Further, the controller 50 may adjust the voltage value of the DC signal Sdc by controlling the DC-DC converter 41 and/or the voltage divider 45. Accordingly, the characteristics of the driving signal Vd may ultimately be changed.

In this case, the controller 50 may control the voltage divider 45 to set the voltage value of the DC signal Sdc to be equal to or greater than the amplitude of the AC signal Sac′. Consequently, the voltage value of the driving signal Vd may be set to be equal to or greater than zero.

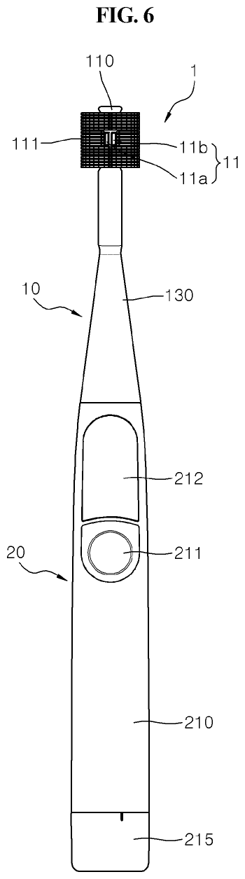

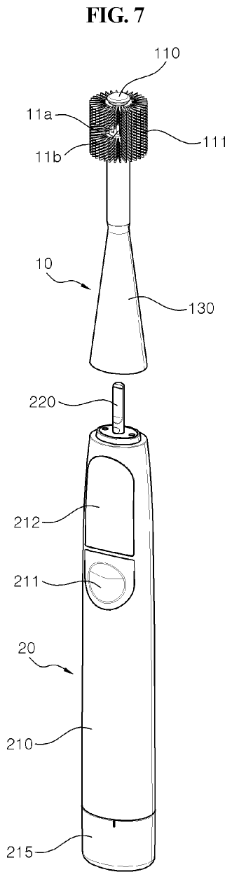

FIG. 6 is a diagram illustrating a pet electric toothbrush according to an embodiment of the present invention in a specific form. FIG. 7 is a diagram illustrating a separated state of a head part and handle part of the pet electric toothbrush shown in FIG. 6.

Referring to FIGS. 1, 6, and 7, the pet electric toothbrush 1 according to an embodiment of the present invention may include the head part 10 and the handle part 20.

The head part 10 may include a toothbrush head 110 and a head body 130, and may be designed in a way that it can be coupled to and separated from the handle part 20. Accordingly, when the head part 10 needs to be replaced due to aging or the like, the user may simply replace the existing head part 10 with a new head part 10.

Bristles 111 and the electrode 11 may be disposed on the toothbrush head 110, and the electrode 11 may include a first electrode 11a and a second electrode 11b.

The first electrode 11a and the second electrode 11b may be disposed inside the toothbrush head 110 while being spaced apart from each other, and the first electrode 11a and the second electrode 11b may be partially exposed from the toothbrush head 110. To this end, the toothbrush head 110 may be provided with an opening that allows the first electrode 11a and the second electrode 11b to be partially exposed.

The first electrode 11a and the second electrode 11b may form an electric field by the driving signal Vd supplied from the signal supply module 40. This electric field may weaken the structure of dental plaque, so the user may effectively remove dental plaque in the oral cavity of the pet using the pet electric toothbrush 1.

Here, a distance between the first electrode 11a and the second electrode 11b may be 0.1 mm to 50 mm. If the distance between the first electrode 11a and the second electrode 11b is set to be less than 0.1 mm or more than 50 mm, it may be difficult to expect effective plaque removal by the electric field generated from the electrodes 11a and 11b.

The first electrode 11a and the second electrode 11b may be formed to have a size suitable for being placed in the toothbrush head 110 of a size suitable for use in the oral cavity of a pet. For example, as shown in FIG. 6, the width of the first electrode 11a that is visible when the pet electric toothbrush 1 is viewed from the front may range from 0.1 mm to 20 mm, and the length of the first electrode 11a may range from 0.1 mm to 30 mm. Additionally, the second electrode 11b may be formed to have the same size as the first electrode 11a.

However, if the width and length of the first electrode 11a and the second electrode 11b are set to less than 0.1 mm, the oral care effect by the electric field may be minimal.

According to an embodiment of the present invention, the first electrode 11a and the second electrode 11b may have a shape that partially protrudes from the toothbrush head 110, and in this case, the first electrode 11a may protrude to a height of 0.1 mm to 3 mm with respect to the surface of the toothbrush head 110. In this configuration, the second electrode 11b may be set to the same height as the first electrode 11a.

This is because if the height of the electrodes 11a and 11b is set to be less than 0.1 mm, there is a possibility that the electrodes 11a and 11b may become buried inside the toothbrush head 110 during an insert injection molding process, and if the height of the electrodes 11a and 11b exceeds 3 mm, discomfort may occur due to a foreign body sensation when brushing teeth, and there is a risk of tooth loss.

The head body 130 may extend from the toothbrush head 110 to form the body of the head part 10. The head body 130 may be designed to have an appropriate length for use, and the distal end of the head body 130 may be coupled to the handle part 20. The head body 130 may be formed separately from the toothbrush head 110 and coupled to it, or may be formed integrally with the toothbrush head 110.

The handle part 20 is the main body of the pet electric toothbrush 1, and may be coupled to the head part 10, and may be provided with a separate fixing pin 220 for fixed coupling with the head part 10.

The signal supply module 40 and the battery 30 for supplying the battery voltage Vb to the signal supply module 40 may be accommodated in the handle part 20. The handle part 20 may be provided with a separate battery cap 215 for purposes such as replacing the battery 30.

Additionally, the handle part 20 may include an outer case 210 for accommodating and protecting internal components. A switch button area 211 and an anti-slip portion 212 may be formed on the outer case 210.

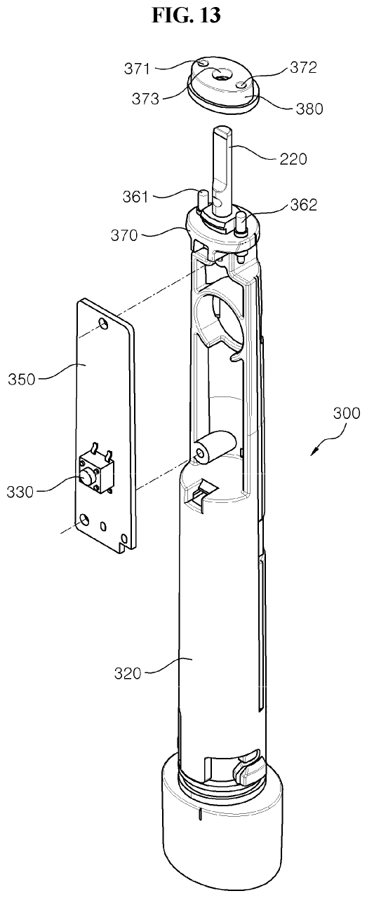

The switch button area 211 is formed at a position corresponding to an internally placed switch 330 (see FIG. 13), and the user is able to control the internal switch 330 by pressing the switch button area 211.

The switch button area 211 and the switch 330 may be for controlling the power on/off status of the pet electric toothbrush 1 and for controlling the characteristics (at least one of amplitude value and DC offset value) of the driving signal Vd. That is, the user of the pet electric toothbrush 1 may operate the switch 330 to turn the power of the pet electric toothbrush 1 on or off, and set the amplitude and/or DC offset of the driving signal Vd to a desired value.

The anti-slip portion 212 is intended to provide the user with a stable grip, and may be designed with a structure and material that enhance friction.

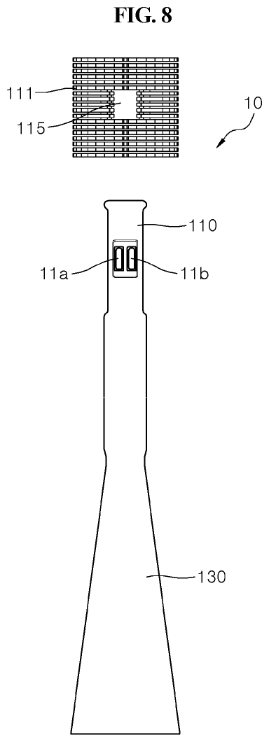

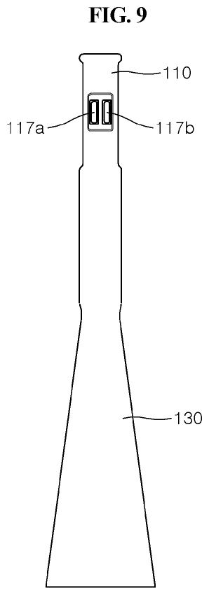

FIG. 8 is a diagram illustrating a state where the bristles are separated from the head part shown in FIG. 6. FIG. 9 is a diagram illustrating the head part with the bristles and electrodes removed.

Referring to FIGS. 8 and 9, the bristles 111 may be designed to be capable of being coupled to and separated from the toothbrush head 110. Accordingly, when the bristles 111 need to be replaced due to aging or the like, the user may easily replace the existing bristles 111 with new bristles 111.

In addition, the bristles 111 may be provided with an opening 115 that allows the first electrode 11a and the second electrode 11b to be partially exposed. Both one end of the first electrode 11a and one end of the second electrode 11b may be exposed through one opening 115. In this case, at least one pair of openings 115 may be formed in the bristles 111 so that the first electrode 11a and the second electrode 11b may be exposed to both sides, i.e., one side and the other side opposite to the one side, of the toothbrush head 110.

The bristles 111 may be made of silicon, but are not limited thereto, and may be made of fine hairs or in a mixed form of fine hairs and silicon.

Next, the toothbrush head 110 may include a pair of first openings 117a that expose parts of the first electrode 11a, and a pair of second openings 117b that expose parts of the second electrode 11b. In this case, the pair of first openings 117a may be formed to face each other, and the pair of second openings 117b may also be formed to face each other.

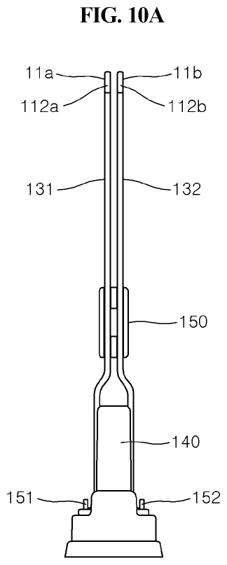

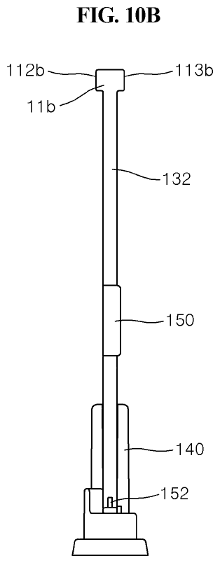

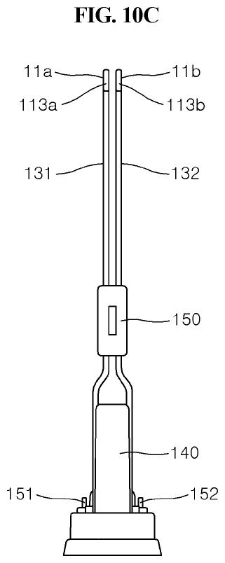

A first end 112a (see FIGS. 10a, 10b, and 10c) of the first electrode 11a may be exposed through one of the pair of first openings 117a, and a second end 113a (see FIGS. 10a, and 10c) of the first electrode 11a may be exposed through the other one of the pair of first openings 117a.

In addition, a first end 112b (see FIGS. 10a, 10b, and 10c) of the second electrode 11b may be exposed through one of the pair of second openings 117b, and a second end 113b (see FIGS. 10a, 10b, and 10c) of the second electrode 11b may be exposed through the other one of the pair of second openings 117b.

Therefore, according to an embodiment of the present invention, the first electrode 11a and the second electrode 11b may be visually recognized by the user through the openings 115 formed in the bristles 111 and the openings 117a and 117b formed in the toothbrush head 110.

FIG. 10A is a front view of a connection relationship between a head cover, a connection line, a connection pin, and a fixture; FIG. 10B is a side view of a connection relationship between a head cover, a connection line, a connection pin, and a fixture; and FIG. is a rear view of a connection relationship between a head cover, a connection line, a connection pin, and a fixture.

Referring to FIGS. 10A, 10B, and 10C, the first electrode 11a may include the first end 112a and the second end 113a located in opposite directions, and the first end 112a and the second end 113a may be areas exposed through the pair of first openings 117a.

Similarly, the second electrode 11b may include the first end 112b and the second end 113b located in opposite directions, and the first end 112b and the second end 113b may be areas exposed through the pair of second opening 117b.

Here, the width of the electrodes 11a and 11b may be formed to be larger than the width of connection lines 131 and 132 to be described later.

Referring to FIGS. 10A, 10B, and 10C, a first connection line 131 and a second connection line 132 for transmitting the driving signal Vd may be disposed inside the head body 130.

The first connection line 131 and the second connection line 132 may be connected to the first electrode 11a and the second electrode 11b, respectively, inside the toothbrush head 110. Specifically, one end of the first connection line 131 may be connected to the central area of the first electrode 11a, and one end of the second connection line 132 may be connected to the central area of the second electrode 11b. In this case, the first end 112a may be located in an electrode area formed by extending in one direction from the central area of the first electrode 11a, and the second end 113a may be located in an electrode area formed by extending in the other direction opposite to the one direction from the central area of the first electrode 11a. In addition, the first end 112b may be located in an electrode area formed by extending in the one direction from the central area of the second electrode 11b, and the second end 113b may be located in an electrode area formed by extending in the other direction from the central area of the second electrode 11b.

Further, the first connection line 131 and the second connection line 132 may be formed to be elongated toward the distal end of the head body 130 so as to receive power from the handle part 20, and may be electrically connected to a first connection pin 151 and a second connection pin 152 disposed on a head cover 140. Specifically, a distal end of the first connection line 131 may be connected to the first connection pin 151, and a distal end of the second connection line 132 may be connected to the second connection pin 152.

For manufacturing convenience, the first connection line 131 and the first electrode 11a may be formed integrally, and the second connection line 132 and the second electrode 11b may also be formed integrally.

Furthermore, the first connection line 131 and the second connection line 132 may be made of the same material as the electrode material described above. The head cover 140 may be coupled to the distal end of the head body 130 to close the distal end of the head body 130.

The first connection pin 151 and the second connection pin 152 may be connected to the first connection line 131 and the second connection line 132, respectively, and may be partially exposed to the outside through the head cover 140.

When the head part 10 and the handle part 20 are subsequently coupled, the connection pins 151 and 152 may be brought into contact with connection terminals 361 and 362 (see FIG. 13) disposed in the handle part 20.

In a fixture 150, a pair of fixing grooves for fixing the positions of the first connection line 131 and the second connection line 132 may be formed to be elongated along a longitudinal direction. The first connection line 131 and the second connection line 132 may be inserted into the pair of fixing grooves.

The fixture 150 may serve not only to secure the positions of the first connection line 131 and the second connection line 132, but also to prevent the first connection line 131 and the second connection line 132 from being brought into contact with each other and being electrically connected. To achieve this, the fixture 150 may be made of an insulating material.

The front of the fixture 150 may have an open shape to facilitate the insertion of the first connection line 131 and the second connection line 132 into the fixture 150. The sides of the fixture 150 have a shape that surrounds the first connection line 131 and the second connection line 132 to prevent them from detaching from the fixture 150. The rear of the fixture 150 may have a shape that is at least partially closed.

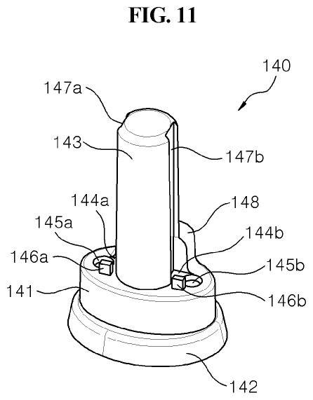

FIG. 11 is a diagram showing a head cover according to an embodiment of the present invention.

Referring to FIG. 11, the head cover 140 may include a pillar member 143 having a groove (not shown) formed therein to accommodate the fixing pin 220.

The pillar member 143 may be disposed at the center of a first base portion 141 and may extend upward. A first seating area 144a and a second seating area 144b may be located on both sides of the pillar member 143, respectively.

Accordingly, the first seating area 144a and the second seating area 144b may be formed on the top surface of the first base portion 141.

In addition, one or more protrusions 146a and 146b may be disposed around the first seating area 144a and the second seating area 144b, respectively. For example, at least one first protrusion 146a surrounding the first seating area 144a, and at least one second protrusion 146b surrounding the second seating area 144b may be formed on the top surface of the first base portion 141.

While FIG. 11 illustrates a case where one first protrusion 146a and one second protrusion 146b are formed, the present invention is not limited thereto, and the number of first protrusions 146a and second protrusions 146b may be variously changed.

A guide wall 148 may be provided around the first seating area 144a and the second seating area 144b, and may surround at least a portion of the lower region of the pillar member 143. The guide wall 148 may be formed to protrude from the first base portion 141 in the longitudinal direction, and the height of the guide wall 148 may be lower than the height of the pillar member 143.

This configuration of the protrusions 146a and 146b and the guide wall 148 may allow the distal ends 131a and 131b of the connection lines 131 and 132 to be stably seated in their respective corresponding seating areas 144a and 144b.

A first pinhole 145a may be formed in the first seating area 144a, and a second pinhole 145b may be formed in the second seating area 144b.

Therefore, the first connection pin 151 may penetrate the head cover 140 through the first pinhole 145a, and the second connection pin 152 may penetrate the head cover 140 through the second pinhole 145b.

Meanwhile, a first guide groove 147a and a second guide groove 147b for guiding the first connection line 131 and the second connection line 132, respectively, may be formed on the pillar member 143 to be elongated along the longitudinal direction.

A second base portion 142 may be formed below the first base portion 141 and may have a larger diameter than the first base portion 141. However, the second base portion 142 may be omitted as needed.

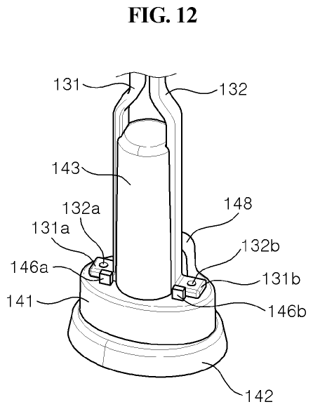

FIG. 12 is a diagram illustrating a connection relationship between a connection line and a head cover shown in FIG. 11.

Referring to FIG. 12, the first connection line 131 and the second connection line 132 may be partially inserted into the first guide groove 147a and the second guide groove 147b of the pillar member 143, respectively. The distal end 131a of the first connection line 131 and the distal end 131b of the second connection line 132 may be bent and seated in the first seating area 144a and the second seating area 144b, respectively.

In this case, the distal end 131a of the first connection line 131 and the distal end 131b of the second connection line 132 may be bent in opposite directions, and may have a first connection hole 132a and a second connection hole 132b corresponding to the first pinhole 145a and the second pinhole 145b, respectively.

For example, the distal end 131a of the first connection line 131 may be seated in the first seating area 144a in a state bent in a first direction, and thus the first connection hole 132a formed in the above distal end 131a may be located on the first pinhole 145a of the first seating area 144a.

In addition, the distal end 131b of the second connection line 132 may be seated in the second seating area 144b in a state bent in a second direction opposite to the first direction, and thus the second connection hole 132b formed in the above distal end 132a may be located on the second pinhole 145b of the second seating area 144b.

Although not shown in FIG. 12, the first connection pin 151 may be disposed to penetrate the first connection hole 132a of the first connection line 131 and the first pin hole 145a of the head cover 140, and the second connection pin 152 may be disposed to penetrate the second connection hole 132b of the second connection line 132 and the second pin hole 145b of the head cover 140.

One end of the first connection pin 151 may be electrically connected to the distal end 131a of the first connection line 131 through a soldering process near the first connection hole 132a, and the other end of the first connection pin 151 may protrude downward through the first pinhole 145a of the head cover 140.

One end of the second connection pin 152 may be electrically connected to the distal end 131b of the second connection line 132 through a soldering process near the second connection hole 132b, and the other end of the second connection pin 152 may protrude downward through the second pinhole 145b of the head cover 140.

For example, the first connection pin 151 and the second connection pin 152 may be implemented as pogo pins with embedded springs.

After the assembly of the head cover, connection line, and connection pin as described above is completed, the toothbrush head 110 and the head body 130 may be formed by performing an insert injection molding process.

FIG. 13 is an exploded view illustrating an internal configuration of a handle part according to an embodiment of the present invention.

The handle part 20 according to an embodiment of the present invention may include the fixing pin 220, a first connection terminal 361, a second connection terminal 362, an upper cover 380, an inner case 300, and a circuit board 350.

The inner case 300 may be accommodated in the outer case 210 and may provide an area and space for installing components such as the circuit board 350 and the battery 30.

At the bottom of the inner case 300A, there may be a battery compartment 320 where the battery 30 is located, and the circuit board 350 may be mounted to the upper side of the battery compartment 320. In this case, although not shown in the drawing, at least one terminal for electrically connecting the battery 30 to the circuit board 350 may be installed in the battery compartment 320.

Additionally, a plate-shaped coupling portion 370 on which the connection terminals 361 and 362 and the fixing pin 220 are installed may be formed on the upper portion of the inner case 300.

The switch 330 used to control power supply by the battery 30 and adjust the characteristics of the driving signal Vd may be installed on the circuit board 350.

Although one switch 330 is shown in the drawing, a switch for turning on or off the power of the pet electric toothbrush 1 and a switch for adjusting the characteristics of the driving signal Vd may be included.

The switch for adjusting the characteristics of the driving signal Vd may be configured to allow the user to set each of an amplitude value and a dc offset value, or alternatively, the switch may be configured to allow the user to select one of two or more modes. For example, when a first mode is selected through the switch, the amplitude value and dc offset value are determined as preset values corresponding to the first mode, and when the second mode is selected through the switch, the amplitude value and dc offset value are determined as preset values corresponding to the second mode.

The circuit board 350 may be fixed to the inner case 300 through a fastening member (not shown) or the like. The signal supply module 40 for generating the driving signal Vd may be mounted on the circuit board 350, and the controller 50 may be further mounted.

The first connection terminal 361 and the second connection terminal 362 may each be disposed to penetrate the coupling portion 370. When the head part 10 and the handle part 20 are coupled, the first connection terminal 361 and the second connection terminal 362 may be brought into contact with the first connection pin 151 and the second connection pin 152 of the head part 10, respectively, thereby serving to transmit the driving signal Vd generated from the signal supply module 40 to the head part 10.

For this purpose, the lower ends of the connection terminals 361 and 362 protruding downward from the coupling portion 370 may be connected to the circuit board 350 on which the signal supply module 40 is mounted, and the upper ends of the connection terminals 361 and 362 protruding upward from the coupling portion 370 may be exposed to the outside through the upper cover 380.

The fixing pin 220 may be disposed in the center of the coupling portion 370 to be elongated upward, and may be inserted and coupled to a fixing pin receiving groove provided in the head part 10.

The upper cover 380 may be installed on the coupling portion 370 of the inner case 300, and may be made of an insulating material such as silicon, for example.

The upper cover 380 may include an opening 371 for exposing the first connection terminal 361 to the outside, an opening 372 for exposing the second connection terminal 362 to the outside, and an opening 373 through which the fixing pin 220 may pass.

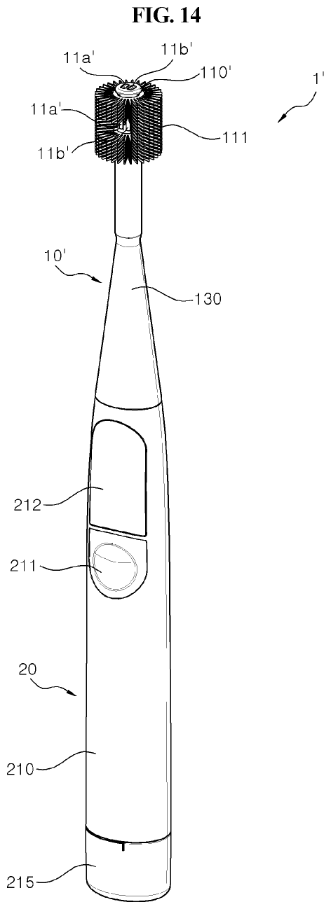

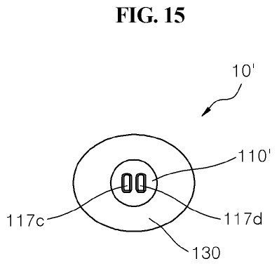

FIG. 14 is a diagram illustrating a pet electric toothbrush according to another embodiment of the present invention. FIG. 15 is a top view of a head part shown in FIG. 14. In describing a pet electric toothbrush 1′ according to another embodiment of the present invention, the same reference numerals are assigned to the same components as in the embodiment described with reference to FIGS. 1 to 13, and redundant descriptions of the above-described embodiment will be omitted while focusing on differences. Therefore, in the following, detailed descriptions will be provided for a toothbrush head 110′, a first electrode 11a′, and a second electrode 11b′.

Referring to FIGS. 14 and 15, the toothbrush head 110′ may include a third opening 117c and a fourth opening 117d provided on the top thereof. The first electrode 11a′ and the second electrode 11b′ may be partially exposed through the third opening 117c and the fourth opening 117d, respectively.

Specifically, there are provided the pair of first openings 117a formed to face each other on the side of the toothbrush head 110′, the pair of second openings 117b formed to face each other on the side of the toothbrush head 110′ and located side-by-side with the first opening 117a, and the third opening 117c and the fourth opening 117d located adjacent to each other on the top of the toothbrush head 110′, so that the first electrode 11a′ and the second electrode 11b′ may each be exposed through three openings.

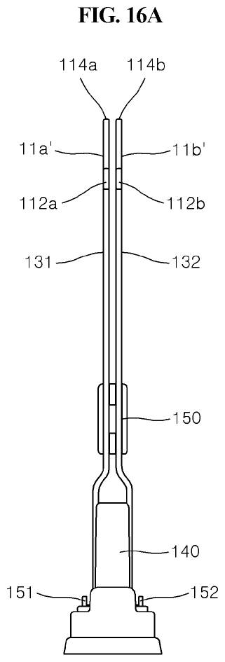

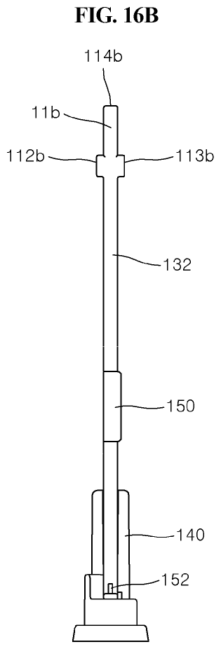

FIG. 16A is a front view of a head part shown in FIG. 14 with a toothbrush head and head body removed; and FIG. 16B is a side view of a head part shown in FIG. 14 with a toothbrush head and head body removed.

Referring to FIGS. 16a and 16b, the first electrode 11a′ may further include a third end 114a, and the third end 114a of the first electrode 11a′ may be positioned between the first end 112a and the second end 113a of the first electrode 11a′.

Further, the third end 114a of the first electrode 11a′ may be one end of an electrode area formed by protruding and extending upward from the central area of the first electrode 11a′. The third end 114a of the first electrode 11a′ may be exposed through the third opening 117c.

The second electrode 11b′ may also include a third end 114b, and the third end 114b of the second electrode 11b′ may be positioned between the first end 112b and the second end 113b of the second electrode 11b′.

Further, the third end 114b of the second electrode 11b′ may be one end of an electrode area formed by protruding and extending upward from the central area of the second electrode 11b′. The third end 114b of the second electrode 11b′ may be exposed through the fourth opening 117d.

According to another embodiment of the present invention, the first electrode 11a′ and the second electrode 11b′ may at least partially have a ‘T’ shape.

Meanwhile, in the drawing, the electrode 11 is shown as including the first electrode 11a and the second electrode 11b, but the present invention is not limited thereto, and the number of electrodes 11 provided on the toothbrush heads 110 and 110′ may be variously changed.

Additionally, the shape of the electrode 11 is not limited to that shown in the drawings, and may be designed in various ways.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An electric toothbrush for pets comprising:
a head part including at least one electrode that receives a driving signal and generates an electric field corresponding to the driving signal, and a toothbrush head on which the at least one electrode is disposed;
bristles coupled to the toothbrush head and including at least one opening that exposes a portion of the at least one electrode;
a handle part connected to the head part and formed in a shape that may be held by a user; and
a signal supply module provided in the handle part and configured to generate the driving signal by mixing an AC signal and a DC signal to supply the driving signal to the at least one electrode.

2. The electric toothbrush for pets of claim 1, wherein the at least one electrode includes a first electrode and a second electrode disposed to be spaced apart from each other and each having a first end and a second end located in opposite directions, and
wherein the toothbrush head includes:
a pair of first openings that expose the first and second ends of the first electrode; and
a pair of second openings that expose the first and second ends of the second electrode.

3. The electric toothbrush for pets of claim 2, wherein the head part further includes:
a head body extending from the toothbrush head;
a head cover closing a distal end of the head body;
a first connection line and a second connection line disposed in the head body and connected to the first electrode and the second electrode, respectively, in the toothbrush head; and
a fixture in which a pair of fixing grooves for fixing positions of the first connection line and the second connection line are formed along a longitudinal direction, and
wherein the fixture is located between the toothbrush head and the head cover.

4. The electric toothbrush for pets of claim 3, wherein the head cover includes:
a pillar member having a first guide groove into which a portion of the first connection line is inserted and a second guide groove into which a portion of the second connection line is inserted formed along the longitudinal direction;
a first seating area and a second seating area, each of which is located on either side of the pillar member;
at least one protrusion disposed around each of the first and second seating areas; and
a guide wall disposed around the first seating area and the second seating area and formed to surround at least a portion of a lower region of the pillar member.

5. The electric toothbrush for pets of claim 4, wherein each of the first electrode and the second electrode further includes:
a third end, which is one end of an electrode area formed by protruding and extending upward from a central area thereof.

6. The electric toothbrush for pets of claim 5, wherein the toothbrush head further includes:
a third opening that exposes the third end of the first electrode; and
a fourth opening that exposes the third end of the second electrode, and
wherein the third opening and the fourth opening are located on a top surface of the toothbrush head.

7. The electric toothbrush for pets of claim 1, further comprising:
a controller configured to control the signal supply module to change at least one of characteristics of the driving signal under user's control.

8. The electric toothbrush for pets of claim 7, wherein the characteristics of the driving signal include an amplitude and a DC offset.

9. The electric toothbrush for pets of claim 1, wherein the signal supply module includes:
a DC-DC converter that receives a battery voltage and converts it into an output voltage;
a signal generator that generates the AC signal using the output voltage of the DC-DC converter;
a filter that performs a filtering operation on the AC signal generated by the signal generator; and
a calibrator that generates the driving signal by mixing the DC signal with the AC signal supplied through the filter.

10. The electric toothbrush for pets of claim 9, wherein the signal supply module further includes a voltage divider that divides the output voltage of the DC-DC converter to generate the DC signal.
